(19) United States
(12) Patent Application Publication
(10) Pub. No.: US 2008/0314367 A1
(43) Pub. Date: Dec. 25, 2008

(54) Control system using pulse density modulation

(76) Inventors: David A. Goulette, Marine City, MI (US); Oscar A. Lecea, Grand Blanc, MI (US)

Correspondence Address: DELPHI TECHNOLOGIES, INC., M/C 480-410-202, PO BOX 5052, TROY, MI, 48007, US

(21) Appl. No.: 11/821,306

(22) Filed: Jun. 22, 2007

(51) Int. Cl. F02M 51/00; F16K 31/02

(52) U.S. Cl. 123/472; 251/129.01

(57) ABSTRACT

A method for modified pulsed control of an electromechanical actuator in accordance with the invention comprising the steps of a) setting a common time length for all of the pulses in a pulse train, and b) varying (modulating) the number of such pulses per unit time (repetition rate) by varying the length of time between pulses in the train. Such control is defined herein as pulse-density modulation, or PDM. Especially in applications having a relatively low percent duty cycle if controlled by the prior art Pulse Width Modulation (PWM), PDM control results in more accurate control of an actuator, with higher resolution. The method is especially useful in controlling flow of a fluid, through a valve, such as a fuel injector, and especially at relatively low flow rates at high supply pressures P1 in the fluid supply.

### TECHNICAL FIELD

The present invention relates to electronic systems for control of electromechanical actuators; more particularly, to pulsed electronic control systems; and most particularly, to an electronic control system employing a fixed width pulse applied at a variable frequency, resulting in modulation of pulse density per unit time.

### BACKGROUND OF THE INVENTION

In the art of electronic control of electromechanical actuators such as valve actuators, it is well known to apply a pulsed electronic signal to the actuator over a percent of unit time (percent duty cycle). Because the time-width of each pulse may be varied between 0% and 100% duty cycle, this approach is known in the art as control by Pulse Width Modulation. In this way, there is a linear relationship between duty cycle and flow of a fluid material through a valve, given a fixed supply pressure to the valve and a fixed pressure drop across the valve. The time-average flow rate of fluid through the valve is proportional to the percent of the duty cycle during which the valve is open, the duty cycle being defined as the period from the start of a pulse to the start of the next succeeding pulse. As the pressure drop across the valve is increased, the relationship of duty cycle to flow remains linear, but the slope increases, resulting in a reduced usable control range with increasing pressure. This limitation can reduce the resolution of control of the actuator. Also, the usable range of flow for a given application can be very small in comparison to the full flow capability of the valve. In this situation, for example, a variation of only a few percent in the duty cycle may encompass the entire range of usable flow, leading to poor actuator position resolution and poor control of flow.

What is needed in the art is an improved strategy for providing pulsed-signal control to a valve actuator that results in increased resolution and more accurate actuator control.

It is a principal object of the present invention to provide an improved control of flow of material through a valve.

### SUMMARY OF THE INVENTION

Briefly described, a method for modified pulsed control of an electromechanical actuator in accordance with the invention comprises the steps of a) setting a common time length for all of the pulses in a pulse train, and b) varying (modulating) the number of such pulses per unit time (repetition rate) by varying the length of time between pulses in the train. Such control is defined herein as pulse-density modulation, or PDM. Especially in applications having a relatively low duty cycle if controlled by the prior art Pulse Width Modulation (PWM), PDM control results in more accurate control of an actuator, with higher resolution. The method is especially useful in controlling flow of a fluid, either liquid or gas, through a valve, and especially at relatively low flow rates at high supply pressures.

### BRIEF DESCRIPTION OF THE DRAWINGS

The present invention will now be described, by way of example, with reference to the accompanying drawings, in which:

FIG. 1 is a schematic diagram of an exemplary valve actuator control system in accordance with the invention;

FIG. 2 is a schematic diagram of a Pulse Density Modulation waveform in accordance with the invention;

FIG. 3 is a graph showing prior art time-average flow rates as a function of PWM duty cycle for fluids provided to a valve at three different supply pressures;

FIG. 4 is a graph showing time-average flow rates as a function of PDM control in accordance with the invention for fluids provided to a valve at three different supply pressures;

FIG. 5 is graph showing pressure upsets in a closed loop pressure controlled fluid supply during an instantaneous change in flow command when using either a prior art PWM flow control duty cycle or PDM control;

FIG. 6 are bar and line graphs showing generally, how flow rate may be ramped up and down, using PDM control, by progressively varying the length of time between pulses; and

FIG. 7 is a graph showing reduction in pressure upsets in a fluid supply during ramped flow control during PDM control in accordance with the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

The present invention in PDM methodology is applicable to control of any electromechanical actuator controllable by PWM control methodology in accordance with the prior art, and is directly replaceable of such PWM control. Such actuators may include but are not limited to linear actuators and rotary actuators. Some typical valve applications are engine throttle valves, engine exhaust gas recirculation valves, and fuel flow control valves for engines and for hydrocarbon fuel reformers. Also, of particular interest, because of the flow accuracy demanded in its application, the PDM methodology is specially suited for use in fuel injectors.

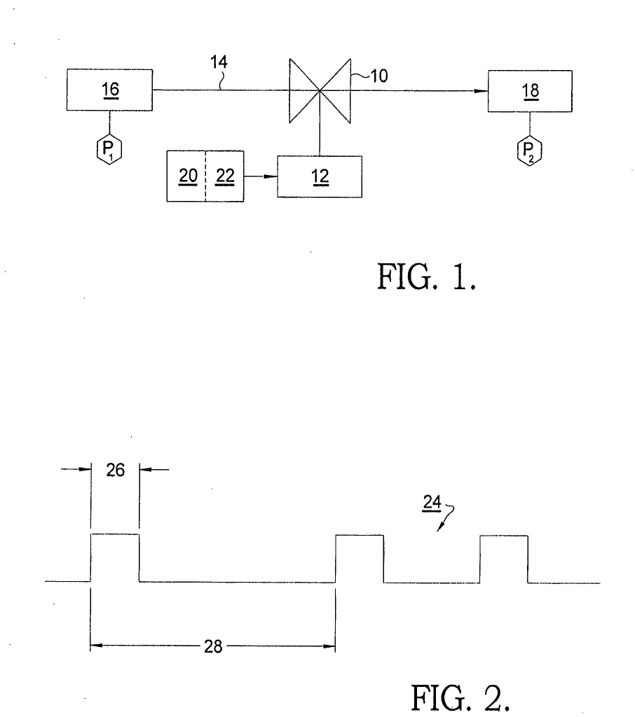

FIG. 1 shows a schematic valve 10 operated by an actuator 12 for controlling flow rate of a fluid 14 through valve 10 from a source 16 at pressure P₁ to a destination 18 at pressure P₂, the difference P₁−P₂ (ΔP) representing the pressure drop across valve 10. Actuator 12 is controlled by an electronic controller 20 and driver 22. Control may be open loop or feedback closed loop as is well known in the prior art of flow control. Fluid 14 may be either a liquid or a gas. FIG. 1 provides structure for the discussion below of PWM and PDM control systems, wherein reference numbers should be understood as coming from the components shown in FIG. 1.

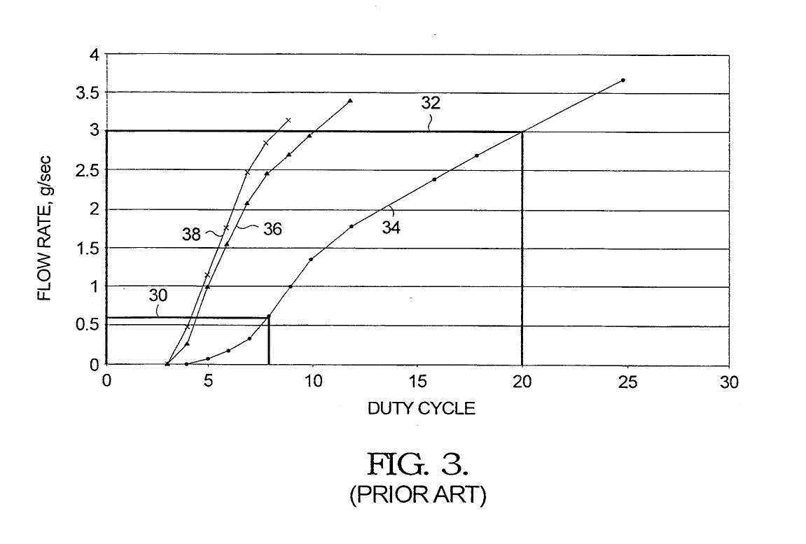

Referring to FIGS. 1 and 2, a representation of a PDM waveform 24 in accordance with the present invention consists of a fixed pulse width 26 and a variable repetition rate 28 (PDM frequency). The fixed pulse width with a fixed ΔP gives a consistent quantity of fluid through valve 10 with each stroke of actuator 12. By varying the repetition rate 28 of actuator 12, the time-average flow of fluid 14 through valve 10 can be controlled very precisely with good resolution over a desired flow range.

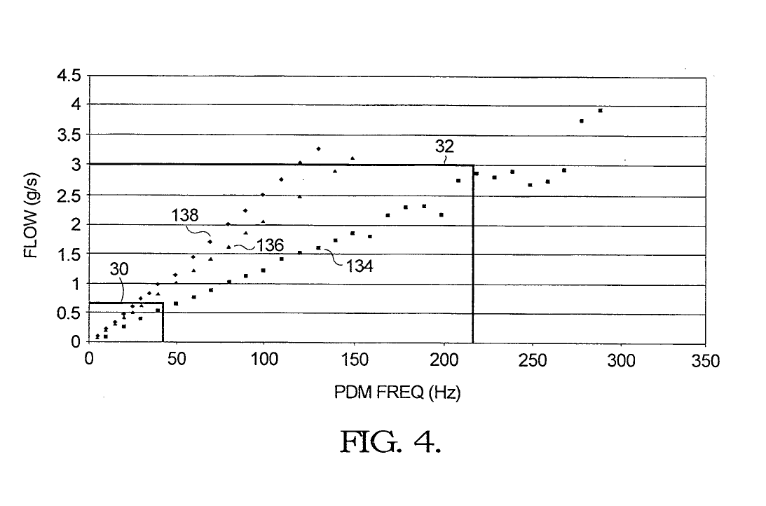

Referring now to FIGS. 3 and 4, a comparison between the prior art PWM control and the present art PDM control is illustrative of the improvement and benefit of Pulse Density Modulation.

In FIG. 3, flow characteristics (time-average flow rate as a function of duty cycle at 125 Hz) are shown for a given valve 10 with varying ΔP when using prior art PWM control, for a low flow rate application (Box 30) and a high flow rate application (Box 32), at three different values of supply pressure P₁. For Curve 34, P₁=300 bar; for Curve 36, P₁=900 bar; and for Curve 38, P₁=1200 bar.

For the low flow rate application 30 at the higher pressures 36,38, the total flow from 0 to 0.6 g/sec is represented by a difference in duty cycle from about 3% to about 4%. Clearly, the resolution is very low, and the ability to control the flow rate accurately over the useful flow range is very poor. Further, for such low percentage duty cycles, the valve spends most of the time closed, and flow then comes in bursts spaced far apart; e.g., a 4% duty cycle on a 100 millisecond cycle basis represents the valve being open for 4 ms and closed for the remaining 96 ms. PWM is clearly an inferior control strategy for these conditions.

Even for the high flow rate application 32, the total flow from 0 to 3.0 g/sec at the higher pressures 36,38 is represented by a difference in duty cycle from about 3% to only about 10%. Note further that the flow response as a function of duty cycle is non-linear for prior art PWM control in these ranges.

In FIG. 4, exemplary flow characteristics (flow rate as a function of PDM frequency) are shown for valve 10 with varying ΔP when using PDM control in accordance with the present invention for the same flow rate applications shown in FIG. 3 at the same supply pressures. This method of control uses a fixed pulse width, each pulse thus giving the same amount of flow, while varying the repetition rate. In this way, two control variables may be employed together to tailor the control methodology to maximize accuracy and resolution, dependent upon actuator characteristics and ΔP. For Curve 134, P₁=300 bar; for Curve 136, P₁=900 bar; and for Curve 138, P₁=1200 bar.

For the low flow rate application 30 at the higher pressures 136,138, the time-average flow from 0 to 0.6 g/sec is represented by a difference in PDM frequency from 0 to about 30 Hz. Thus, for comparison to the above PWM example, for the equivalent of a 4% duty cycle in a 100 ms period, at a 30 Hz repetition rate, the valve cycles three times instead of only once, each pulse lasting 1.33 ms instead of 4 ms.

Clearly, the resolution is much improved over PWM as is the ability to control the flow rate accurately over the useful flow range. Note that resolution may be increased easily by simply changing the range of repetition, for example, 0-75 Hz. Further, as is seen below, for such low percentage duty cycles, although the valve still spends most of the time closed, flow then comes in small bursts spaced relatively closely together. PDM is clearly a superior control strategy for these conditions.

It should also be noted that PDM offers simplification in valve characterization over the prior art PWM method. In a system with varying ΔP across valve (10), the prior art PWM method of control would require known characteristics of the valve (10) for multiple duty cycles for each ΔP over the range of operating pressures. In comparison a system operating using PDM would only require a single data point pf flow per fixed stroke at each ΔP. Because of the linearity with PDM multiple points at each ΔP would not be required, for example by doubling the PDM frequency the resultant flow would double. In this way characterization and calibration of the valve (10) is simplified.

For the high flow rate application 32, the time-average flow from 0 to 3.0 g/sec at the higher pressures 136,138 is represented by a difference in PDM frequency from 0 to about 145 Hz, providing very high resolution and flow accuracy. Note further that the flow response as a function of PDM frequency is linear in these ranges.

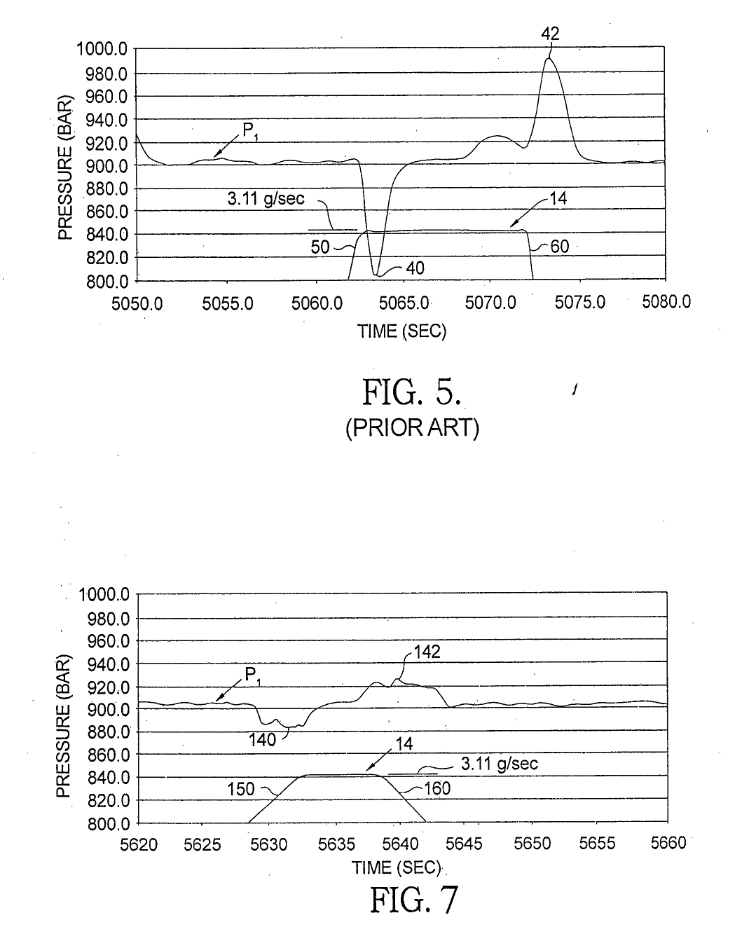

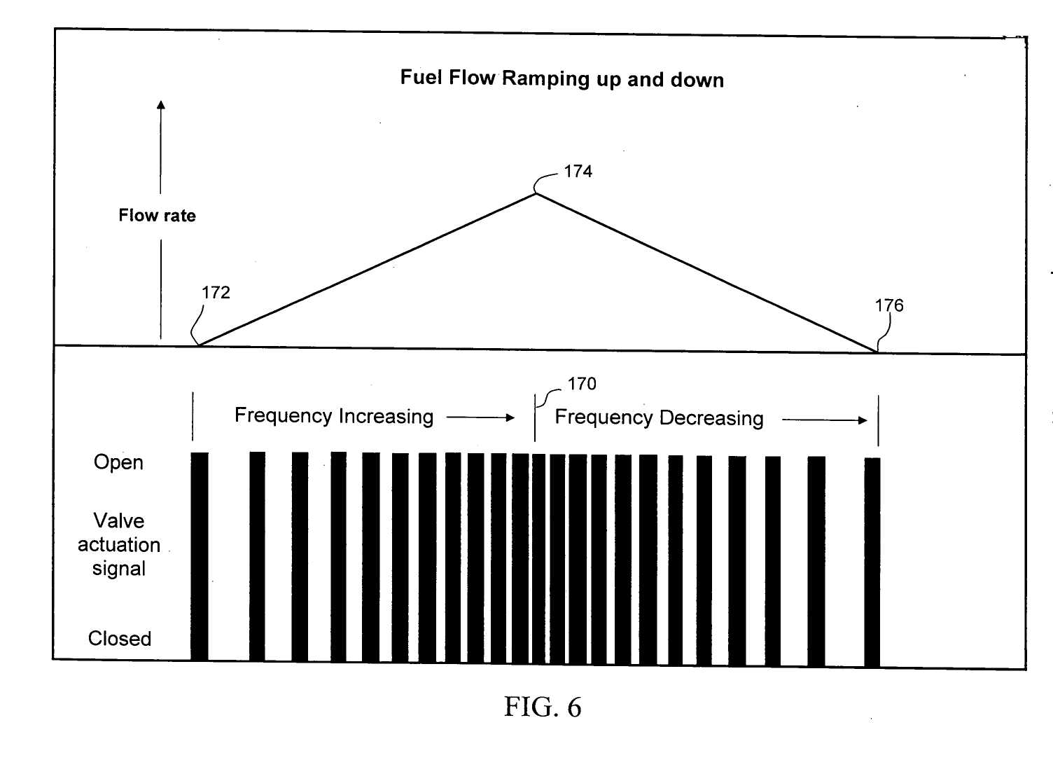

The opening and closing of a valve in response to an actuator pulse, in either PWM control or PDM control, can result in substantial spikes in pressure P₁, which pressure fluctuations may adversely affect other functions (not shown) also drawing on fluid supply 16. Referring now to FIGS. 5 and 6, an additional advantage of PDM control is shown.

In FIG. 5, valve 10 is operated instantaneously to allow full commanded flow at about 5062 seconds and shut off at about 5073 seconds, providing a period of about 10 seconds at a flow rate of fluid 14 of 3.11 g/sec. Onset 50 of flow is sudden, resulting in a sharp drop 40 in P₁ from about 900 bar to about 800 bar. P₁ recovers over a period of a few seconds and then experiences a sharp increase 42 at shutdown 60 to about 990 bar when the valve is slammed shut.

FIG. 6 shows generally how, with a PDM control, flow rate may be gradually ramped up and/or down by controllably and progressively varying the length of time between pulses. The lower bar graph portion of FIG. 6 progressively decreases the length of time between pulses, from left to right, until mid-point 170 is reached, then continues from left to right to progressively increase the length of time between pulses. The line graph portion in FIG. 6, above the bar graph, reflects the corresponding gradual flow rate change from starting point 172, to mid-point 174 then back to finish point 176.

In FIG. 7 (PDM control), both the onset 150 and shutdown 160 are “ramped” by varying the repetition rate to provide minimal corresponding upsets 140,142 in P₁. Total flow volume (area under the curves showing a flow rate of 3.11 g/sec) is the same for both control methods (FIGS. 5 and 7), but PDM clearly can provide smoother flow onset and shutdown by ramping, resulting in less pressure upset in fluid source 16.

In summary, the distinction between the prior art PWM control and the present invention PDM control is that PWM control is based on a fixed time interval known as the duty cycle, and the controlling pulse occupies a variable length and therefore variable percentage of the fixed-length duty cycle; whereas PDM control is based on a fixed-length pulse, and time average actuation is achieved simply by shortening or lengthening the time length between the fixed-length pulses. Thus, in PDM control there is no fixed length duty cycle, but rather the pulse length may be fixed at any given value for all the pulses in a pulse train and the inter-pulse length then varied as desired to achieve a desired time-average actuation duty cycle consistent with the flow parameters and hardware capabilities of any application.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A method for controllably energizing an electromechanical actuator by providing a series of energizing electrical pulses to the actuator wherein the electrical pulses are separated by non-energizing periods of time, comprising the steps of:
a) setting a common time length for each of said energizing pulses; and
b) varying the length of said non-energizing time periods between said pulses to vary the time-average duty cycle of said actuator.

2. A method in accordance with claim 1 wherein the length of said non-energizing time periods between said pulses in said varying step progressively changes to cause flow rate ramping.

3. A system for controlling a time-average flow rate of a fluid through a valve, comprising:
a) an electromechanical actuator operatively associated with said valve; and
b) an electronic controller operatively associated with said electromechanical actuator and programmed to provide a series of energizing electrical pulses to said actuator,
wherein adjacent of said electrical pulses are separated by non-energizing periods of time,
wherein a common time length is set for each of said energizing pulses, and
wherein said length of said non-energizing time periods between said pulses are varied to vary the time-average duty cycle of said actuator to control said time-average flow rate.

4. A system in accordance with claim 3 wherein said controller is further programmed with a target time-average flow rate for said fluid, and wherein said varying of said length of said non-energizing time periods is adjusted to cause said time-average flow rate to equal said target time-average flow rate.

5. A system in accordance with claim 4 wherein said controller is operated in a control mode selected from the group consisting of open loop and closed loop.

6. A system in accordance with claim 3 where said fluid is selected from the group consisting of liquid and gas.

7. A system in accordance with claim 3 wherein said actuator is selected from the group consisting of linear and rotary.

8. A fuel injector for controlling a time-average flow rate of fuel through a valve, comprising:
a) an electromechanical actuator operatively connected to said valve; and
b) an electronic controller operatively associated with said electromechanical actuator and programmed to provide a series of energizing electrical pulses to said actuator,
wherein adjacent of said electrical pulses are separated by non-energizing periods of time,
wherein a common time length is set for each of said energizing pulses, and
wherein said length of said non-energizing time periods between said pulses are varied to vary the time-average duty cycle of said actuator to control said time-average flow rate of said fuel injected by said fuel injector.
